(19) United States
(12) Patent Application Publication
(10) Pub. No.: US 2012/0050168 A1
(43) Pub. Date: Mar. 1, 2012

(54) HANDHELD INPUT DEVICE

(75) Inventors: SHEN-CHUN LI, Tu-Cheng (TW); SHOU-KUO HSU, Tu-Cheng (TW); HSIEN-CHUAN LIANG, Tu-Cheng (TW); YU-CHANG PAI, Tu-Cheng,Taipei Hsien (TW); WEN-LAING TSENG, Tu-Cheng (TW)

(73) Assignee: HON HAI PRECISION INDUSTRY CO., LTD., Tu-Cheng (TW)

(21) Appl. No.: 12/889,421

(22) Filed: Sep. 24, 2010

(30) Foreign Application Priority Data
Aug. 24, 2010 (TW) 99128178

(51) Int. Cl. G06F 3/02; G06F 3/041

(52) U.S. Cl. 345/169; 345/173

(57) ABSTRACT

A handheld input device includes a main body. The main body includes a first sidewall, a second sidewall, and a touch pad. The first sidewall is arc shaped and includes function buttons. The second sidewall is substantially perpendicular to the first sidewall. The touch pad is positioned on one end of the main body.

### BACKGROUND

1. Technical Field

The present disclosure relates to peripherals of computers, and particularly, to a handheld input device used for the computer.

2. Description of Related Art

A mouse and a keyboard, as an information input devices, are widely used to transmit commands to a computer. When the keyboard is to be used, hands of a user need on the keyboard. When the mouse is to be used, one of the hands may need to leave from an upper area of the keyboard to operate the mouse to control the computer, which may cause fatigue after long periods of use by the user.

Therefore, a handheld input device is desired to overcome the limitations described.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is an exploded, isometric view of a handheld input device according to an exemplary embodiment.

FIG. 2 is an exploded, isometric view of FIG. 1, but viewed from another aspect.

FIG. 3 is an assembled, isometric view of FIG. 1.

### DETAILED DESCRIPTION

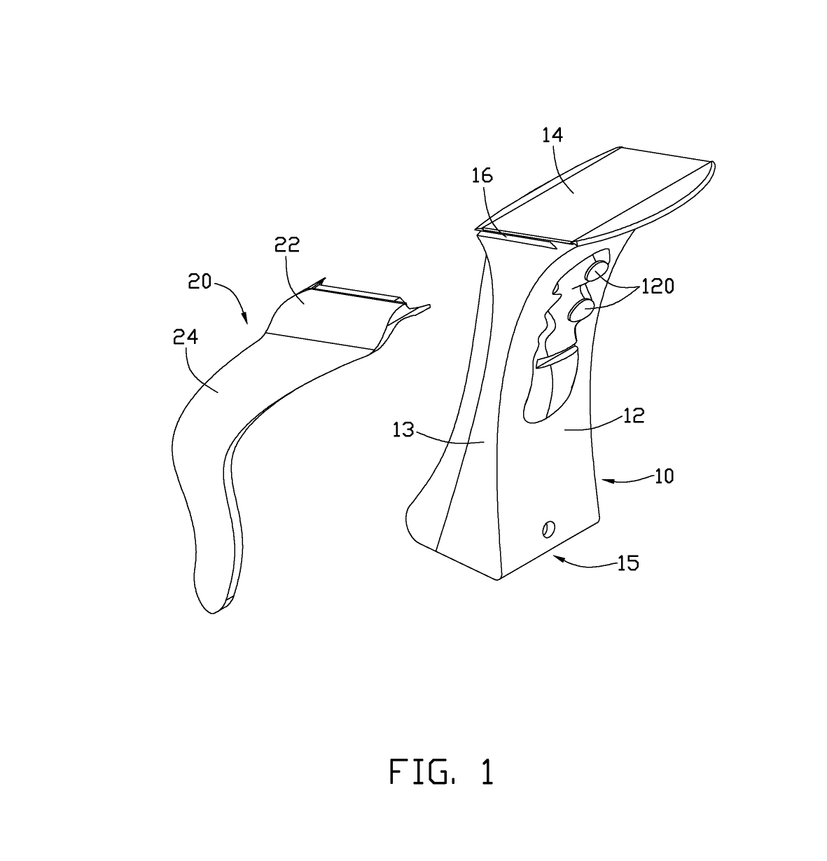

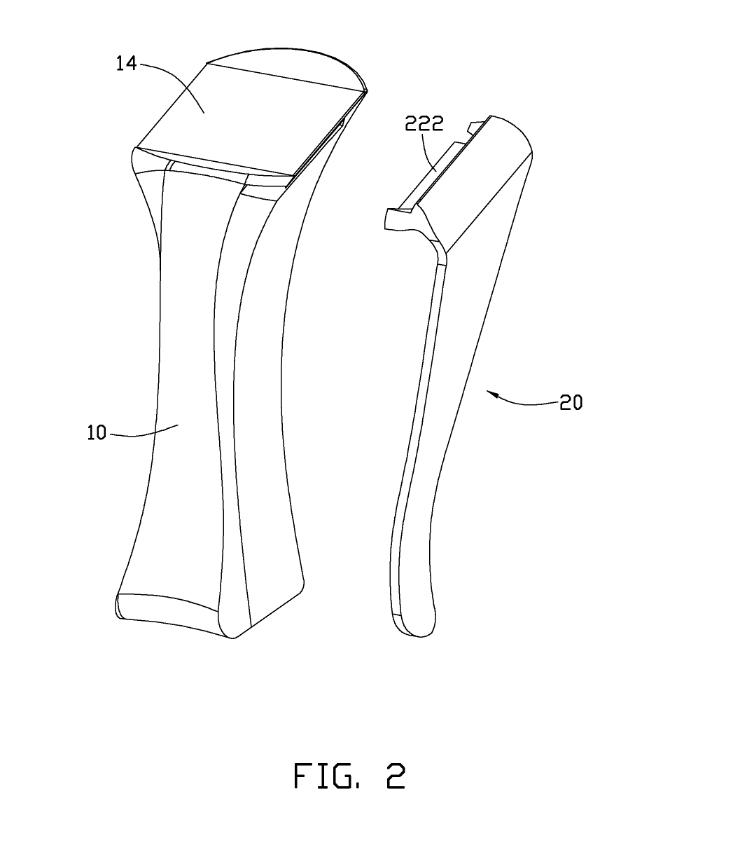

Referring to FIGS. 1-2, an exemplary embodiment of a handheld input device includes a main body 10, and a handle 20 attachable to or removable from the main body 10.

The main body 10 includes a first sidewall 12, a second sidewall 13, a touch pad 14, and a storage portion 15 opposite to the touch pad 14. The first sidewall 12 is arc shaped and includes a plurality of function buttons 120 such as a right button, a left button, or a scroll wheel of the mouse. The second sidewall 13 is substantially perpendicular to the first sidewall 12. The touch pad 14 is positioned on one end of the main body 10. The storage portion 15 is positioned on another end of the main body 10 and accommodates batteries, electric wires, or wireless modules, opposite to the touch pad 14. The second sidewall 13 defines a locking slot 16 adjacent the touch pad 14 of the main body 10.

The handle 20 includes a fixing portion 22 and a handle member 24 arcuately extending from one end of the fixing portion 22. Another end of the fixing portion 22 includes a latching plate 222 extending therefrom. The latching plate 222 corresponds to the locking slot 16.

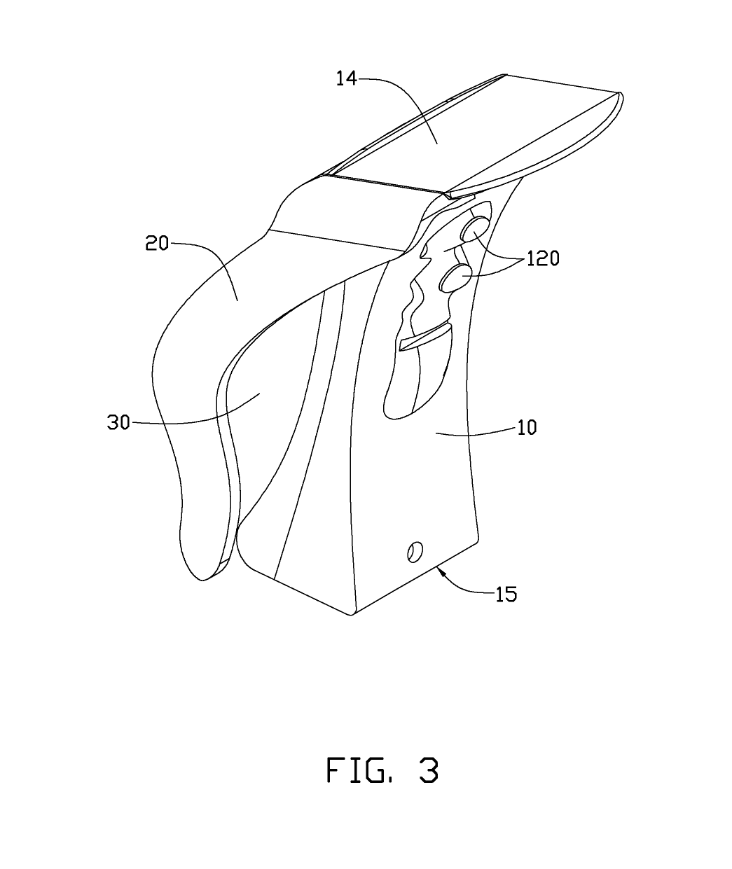

Referring to FIG. 1 and FIG. 3, in assembly of the handle 20 to the main body 10, the latching plate 222 of the handle 20 is received in the locking slot 16 of the second sidewall 13 of the main body 10. The handle member 24 of the handle 20 and the second sidewall 13 of the main body 10 cooperatively define a receiving space 30 therebetween.

In use, fingers of a user pass through the receiving space 30 and hold the first sidewall 12 of the main body 10. A palm of the user is positioned between the handle member 24 of the handle 20 and the second sidewall 13 of the main body 10, and the thumb is positioned outside of the touch pad 14. The handheld input device is held in place on the hand when a keyboard in use. The handheld input device is still positioned on the hand when the handheld input device is to be used, without the necessity of reaching away from the keyboard.

In use, if the user so desires, the handle 20 can be removed from the main body 10, and the main body 10 can be positioned on a desk and used as a stand-alone input device as well.

While the disclosure has been described by way of example and in terms of preferred embodiment, it is to be understood that the invention is not limited thereto. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A handheld input device, comprising:
a main body comprising a first sidewall, a second sidewall substantially perpendicular to the first sidewall, and a touch pad positioned on one end of the main body, wherein the first sidewall is arc shaped and comprises a plurality of function buttons.

2. The handheld input device of claim 1, further comprising a handle attachable to or removable from the main body, wherein the handle comprises a fixing portion and a handle member arcuately extending from one end of the fixing portion.

3. The handheld input device of claim 2, wherein another end of the fixing portion comprises a latching plate extending therefrom to engage with the main body.

4. The handheld input device of claim 3, wherein the second sidewall defines a locking slot adjacent the touch pad of the main body to engage with the latching plate.

5. The handheld input device of claim 2, wherein the handle member and the second sidewall of the main body cooperatively define a receiving space therebetween.

6. The handheld input device of claim 1, wherein one of the plurality of function buttons is a right button, a left button, or a scroll wheel.

7. A handheld input device comprising:
a main body comprising a first sidewall, a second sidewall substantially perpendicular to the first sidewall, a touch pad positioned on one end of the main body, and a storage portion positioned on another end of the main body, wherein the first sidewall is arc shaped and comprises a plurality of function buttons.

8. The handheld input device of claim 7, further comprising a handle attachable to or removable from the main body, wherein the handle comprises a fixing portion and a handle member arcuately extending from one end of the fixing portion.

9. The handheld input device of claim 8, wherein another end of the fixing portion comprises a latching plate extending therefrom to engage with the main body.

10. The handheld input device of claim 9, wherein the second sidewall defines a locking slot adjacent the touch pad of the main body to engage with the latching plate.

11. The handheld input device of claim 8, wherein the handle member and the second sidewall of the main body cooperatively define a receiving space therebetween.

12. The handheld input device of claim 7, wherein one of the plurality of function buttons is a right button, a left button, or a scroll wheel.
